(19) United States
(12) Patent Application Publication
(10) Pub. No.: US 2012/0219839 A1
(43) Pub. Date: Aug. 30, 2012

(54) MECHANICALLY FLEXIBLE AND POROUS COMPENSATING ELEMENT FOR CONTROLLING THE TEMPERATURE OF ELECTROCHEMICAL CELLS

(75) Inventors: Peter Kritzer, Forst (DE); Christoph Weber, Laudenbach (DE); Ulrich Schneider, Darmstadt (DE); Rudolf Wagner, Muelheim (DE); Thomas Arnold, Fuerth (DE)

(73) Assignee: CARL FREUDENBERG KG, Weinheim (DE)

(21) Appl. No.: 13/509,301

(22) PCT Filed: Nov. 4, 2010
(86) PCT No.: PCT/EP10/06714

§ 371 Date: May 11, 2012

(30) Foreign Application Priority Data
Nov. 11, 2009 (DE) 10 2009 052 508.4

(51) Int. Cl. H01M 10/50

(52) U.S. Cl. 429/120

(57) ABSTRACT

The invention relates to a battery comprising at least two cells positioned beside one another, which form an interspace therebetween, with the aim of providing a battery, the cells of which following simple fabrication and positioning, are permanently accommodated in a material-preserving manner in the batter. Said battery is characterized in that the interspace is filled with a porous and deformable compensating element for controlling the temperature of the cells.

### CROSS REFERENCE TO RELATED APPLICATIONS

This is the U.S. National Phase Application under 35 U.S.C. §371 of International Patent Application No. PCT/EP2010/006714 filed Nov. 4, 2010, which designated the United States and was published in a language other than English, which claims the benefit of German Patent Application No. 10 2009 052 508.4 filed on Nov. 11, 2009, the disclosures of which are incorporated by reference herein in their entirety.

### FIELD OF THE INVENTION

The present invention relates to a battery comprising at least two cells positioned side by side, which between the two form an intermediary space.

### BACKGROUND

Large batteries are constructed of individual cells. These are generally housed in a casing and sometimes subdivided into what are referred to as “stacks”. Typically, a battery for hybrid or electric cars, or for industrial purposes, in particular intermediate power storage, contains between twenty and several hundred individual stacks.

These individual cells may be in the form of round cells or prismatic cells, both having a solid casing, or in the form of what is referred to as “coffee-bag” cells, in which the housing is designed as a foil coated with metal on both sides. For optimum space utilization prismatic cells or “coffee-bag” cells are used.

Due to the high amount of stored energy, large batteries always present a safety risk when fault conditions occur. Examples of typical electrical parameters of automobile battery types are listed in the table below.

| | Battery | Battery | |
|---|---|---|---|
| | voltage | capacity | Battery |
| | [V] | [kWh] | technology |
| Mild hybrid | 50-100 | 1 | NiMH/Li-Ion |
| (parallel) | | | |
| Full hybrid | 200-300 | 1.5 | NiMH/Li-Ion |
| (parallel) | | | |
| Plug-in | >300 | 10 | Li-Ion |
| Hybrid | | | |
| (serial) | | | |
| Pure EV | >300 | >30 | Li-Ion |
| Fuel Cell | 200-300 | 1.5 | NiMH/Li-Ion |
| EV | | | |

In this case, lithium batteries are to be viewed more critically as opposed to NiMH batteries since the former have a higher energy density, thinner separators, a combustible electrolyte, higher voltages and lithium.

To ensure the long life of a battery, it is also necessary to maintain within the latter as constant a temperature as possible. Here, a maximum temperature differential of 3 K is ideal and must not exceed a maximum temperature differential of 5 K.

The aforementioned prismatic cells or the “coffee-bag” cells may be installed with minimum space requirements, so that large amounts of energy per unit volume are obtained. Such an intrinsically positive arrangement creates technical difficulties when maintaining a constant temperature and realizing impact and shock resistance.

These requirements are met in the prior art by the insertion of sealing compounds. The disadvantage of this solution, however, is that the sealing compounds are very heavy and normally exhibit a density of greater than 2 kg/l.

Furthermore, fabricating the sealing compounds requires costly and complex steps since it is frequently necessary to cross-link two components. In addition, it is necessary to obtain a high density with respect to the electrolytes. In such case, high pressures may build in a “free space” when a cell is venting.

Thermal expansion of the sealing compound creates pressure on the electrical contacts and thus the risk that said contacts could become detached, which would lead to battery failure.

A further disadvantage is that the sealing compounds creep. Thus, an undesirable penetration of the sealing compound between the contacts cannot be discounted.

### SUMMARY

The object of the present invention is therefore to provide a battery with cells that, once they are fabricated in a simple manner and positioned, are permanently and protectively accommodated in the battery.

The present invention achieves the aforementioned object by means of a battery, comprising at least two cells positioned side by side, which between the two form an intermediary space, wherein the intermediary space is filled with a porous and deformable compensating element for controlling the temperature of the cells.

Accordingly, the above mentioned battery is characterized in that the intermediary space is filled with a porous and deformable compensating element for controlling the temperature of the cells.

According to the present invention, it is recognized that the arrangement of a porous and deformable compensating element between the cells of a battery produces several positive effects. The compressibility of this arrangement can ensure tolerance compensation during fabrication. It prevents cells from being too severely compressed and as a result thereof becoming damaged during fabrication. In addition, it is ensured that electrical contacts at the upper end of the cells become slightly flexible. The compensating elements disposed between the cells serve inter alia as a mechanical buffer. This is especially advantageous in the event of shocks to the battery. Especially in lithium cells a volume work occurs during electrochemical processes, which in the case of so-called “coffee-bag” cells is transferred to a flexible casing. Here, typical values between maximum and minimum volumes run 3-5%. Such volume work can be compensated by compensating elements interposed between the “coffee-bag” cells. Furthermore, the use of porous compensating elements allows for the accommodation of electrolytes, which are able to exit the cells in the event of battery failure.

Thus, the aforementioned object is achieved.

The compensating element could have a thermally conductive surface, which is advantageous for ensuring a good and rapid cooling or heating of a battery. Further advantageous is the fact that a cold battery can be quickly brought up to operating temperature. It is advantageous to heat batteries at temperatures below 0° C. since cold batteries are not as efficient as moderately heated batteries. This has to do with a smaller capacity and smaller currents capable of being tapped. Furthermore, charging cold lithium batteries, especially in the case of high currents, can lead to dendrite buildup. Dendrites are conductive crystalline growths which can cause micro short-circuiting.

Controlling the temperature of the cells can be achieved in a number of ways. Contact cooling could take place via the two metal electrode discharge plates. This is a preferred method because heat transfers most effectively via the electrodes into the cell. In addition, the electrodes are as a rule fixedly connected, making a contact cooling easily possible.

Contact cooling could also take place by way of the sealing seam of a cell. This, too, has found practical use. The heat transfer at the interface sealing seam—cell interior is less than the heat transfer during cooling of the two electrode discharge plates since the cell foil is coated on both sides with thermally non-conductive polymers, and the electrode discharge plates in the cell are again surrounded by a thermally non-conductive separator membrane.

Cooling could take place by contact with the cell surface. This option has hereto not been considered since in this case the heat transfer through the foil into the cell interior is worse by a factor of 10-100 than in the case of cooling via the electrode discharge plates. This is due to the layered structure of the cell interior. In the case of surface area cooling, the heat must be dissipated perpendicularly through the layered structure of the conductive electrodes and of the non-conductive separator. Moreover, the cell surface is not fixed per se due to the volume work of the cell since charged cells are approximately 5% thicker than uncharged cells. This makes thermal contacting difficult. From this type of cooling in particular arise important advantages that are illustrated in the following table:

| | Electrode | Sealing seam | Surface |
|---|---|---|---|
| | cooling | cooling | cooling |
| Effective surface | 2 * 50*0.2 mm² = | 2 * 1,000 * 5 mm² = | 2 * 200 * 300 mm² = |
| cross-section | 20 mm² | 10,000 mm² | 120,000 mm² |
| Heat transfer | x | 0.1x | 0.01x |
| coefficient | | | |
| Product | 20x | 1,000x | 1,200x |
| cross-section * | | | |
| heat transfer | | | |
| coefficient | | | |
| Heating possible | NO | YES | YES |

The foregoing table clearly shows that electrode cooling is least effective. The currently least favored surface cooling on the other hand offers the most favorable overall effects due to the high effective cooling surface.

The main portion of heat should be directly transferable to the areas of the cell surfaces without heat transitioning into the compensating element. It is therefore preferred to use as compensating element a highly porous, resilient material with high restoring force. For this, a minimum spacing between cells must be ensured so that free convection results in an equalization of temperature. In the case of coil cells comprising approximately 400 ml, this spacing is preferably about 5 mm.

An essential requirement for a functioning surface cooling is a solid contact between the cells and the compensating element disposed in between. The absence of a mechanical contact, for example, due to a cushion of air between the compensating element and the cell surface, drastically reduces the cooling effect. The compensating element must be able to conform to the expansion of the cell in the z-direction. In addition, the compensating element must be thermally conductive at least on the surface that faces the cell. Thermal conductivity of the entire compensating element is technically preferred, but for reasons of cost, certainly not optimal. Especially preferred is a material that is flexible, reversibly compressible and thermally conductive on at least one surface, open-pored and having a total porosity in the uncharged state of greater than 20%. This porosity permits compression in the z-direction which can conform to the changes in thickness of the cells. Such reversibility ensures that the compensating element is able to conform to the cells as they become thinner, or cell surfaces, thereby always making mechanical contact with the surface.

Given the aforementioned, a non-woven material in particular could be laminated onto thermally conductive substrates or foils. The non-woven materials could also include carbon fibers or a metallic coating. In this way, non-woven materials exhibit heat conducting properties. They offer excellent heat conductivity and are flexible at the same time. The entire non-woven material could be rendered conductive, which can be accomplished using conductive fibers, metal, graphite, carbon, carbon nanotubes, fibers coated with metal (by galvanic separation or CVD-separation), heat conducting particles, metal, ceramics, in particular Al₂O₃, carbon black, in particular conductive carbon black, graphenes and/or other conductive carbon-variations. Thermally conductive fibers or filaments, in particular metal fibers, could be incorporated in the non-woven material. In addition, it would be possible to use polymer fibers made of polyamide, polyester, polyacrylnitride or polyvinyl alcohol.

In particular, “coffee-bag” cells may be uniformly temperature controlled by means of a thermally conductive non-woven material applied over the entire surface thereof. In this context, it is conceivable to have non-woven material incorporating Al₂O₃, SiC, glass, conductive carbon black, graphite foils, aluminum foils or with metal fibers.

The compensating element could be attached to a heating or cooling device for controlling the temperature of the cells. Heating allows the cells to be actively heated, the cooling device allows the cells to be actively cooled.

The compensating element could be in the form of a ply that surrounds the cells in zigzag fashion. This configuration allows for the use of a single ply for enveloping at least in part a plurality of cells. In this context, it is conceivable to configure the ply as a non-woven material, paper, woven fabric, non-woven fabric or knitted fabric.

The compensating element could be made of an elastomer material or configured as an elastomer ply. It is also conceivable to position multiple plies between two cells. The elastomer material could be heat conductive in order to cool the cells, to heat them or to maintain the cells at a constant temperature. In this arrangement, the elastomer material could be in the form of a molded part with grooves having the same configuration as a bar of chocolate. The elastomer material can function as a framework for “coffee-bag” cells.

In this context, it is also conceivable for the compensating element to include foam material or to be fabricated from a foam material. Foam materials may be open-pored and allow the venting of gases.

The compensating element could also include a non-woven material or be fabricated from a non-woven material. The arrangement of non-woven materials between the cells of a battery has several positive effects. Because non-woven materials are compressible, it is possible to ensure tolerance compensation during fabrication. This prevents cells from being too severely compressed and as a result thereof becoming damaged during fabrication. In addition, it is ensured that electrical contacts at the upper end of the cells are slightly flexible. The non-woven materials disposed between the cells function as a mechanical buffer. This is especially advantageous in the event of shocks to the battery. Especially in lithium cells a volume work occurs during electrochemical processes which in the case of so-called “coffee-bag” cells is transferred to a flexible casing. Here, typical values between maximum and minimum volumes run 3-5%. Such volume work can be compensated by non-woven materials interposed between the “coffee-bag” cells. Furthermore, the use of non-woven materials allows the accommodation of electrolytes which are able to exit the cells in the event of battery failure. This effect is particularly advantageous when recycling the battery, since the latter does not leak. The open-pore configuration of non-woven materials allows for rapid out-gassing or venting of an electrolyte in the event of an external short circuiting of the battery. Non-woven materials, particularly those with high porosity, are low in density. A polyester non-woven with a polymer density of 1.4 kg/1 has at 50% porosity a density of just 0.7 kg/l.

The compensating element could be of flame-retardant construction. So-called “fire blocker” non-woven materials are advantageous for suppressing fires that originate in the battery. Such fires can be caused by short circuits, overloads or mechanical damage. In addition, flame-retardant non-woven materials offer protection from fire from external sources impacting the battery.

The compensating element could include adhesives. Applying adhesive-glues can render non-woven materials in particular slightly sticky, allowing said non-woven materials to be easily arranged and fixed during battery production. In this context, it is conceivable to use hot-melt adhesives, such adhesives being easy to process.

The compensating element could include super-absorbent materials, which allows for management of moisture within the battery. Using non-woven materials containing hydrophilic properties could prevent condensates in the battery. This can be accomplished with the aid of absorbent or superabsorbent substances in the non-woven material disposed within the battery casing. This also aids in the absorption of steam.

The compensating element could include embossing, in particular deep-drawn regions, which enhance the compressibility of the former. Embossing allows in particular a non-woven material with suitable compressibility to be produced. The embossing could be configured geometrically, resulting in a non-woven material with optimum flexibility.

The batteries described herein may be used in vehicles, in particular motor vehicles, aircraft and in other mobile applications requiring a battery. It is further conceivable to use the battery in stationary applications as well.

There are various possibilities for advantageously developing and refining the teaching of the present invention. In this regard, reference is made on the one hand to the subordinate claims, on the other hand to the following description of preferred exemplary embodiments of the battery according to the present invention with reference to the drawings.

In conjunction with the description of the preferred exemplary embodiments with reference to the drawings, generally preferred developments and refinements of the teaching are discussed.

### BRIEF DESCRIPTION OF THE DRAWINGS

FIG. 1 on the left is a top view of an arrangement of two cells and on the right a lateral view of the two cells, between which a non-woven material is accommodated for controlling the temperature of the cells.

FIG. 2 on the left is an arrangement of three cells, between which compensating elements coated on both sides are accommodated, on the right an arrangement of three cells, between which compensating elements coated on one side are accommodated, and

FIG. 3 is an arrangement of two cells, between which a compensating element is accommodated, wherein a pressure sensor and a temperature sensor are arranged between the cells.

### DETAILED DESCRIPTION

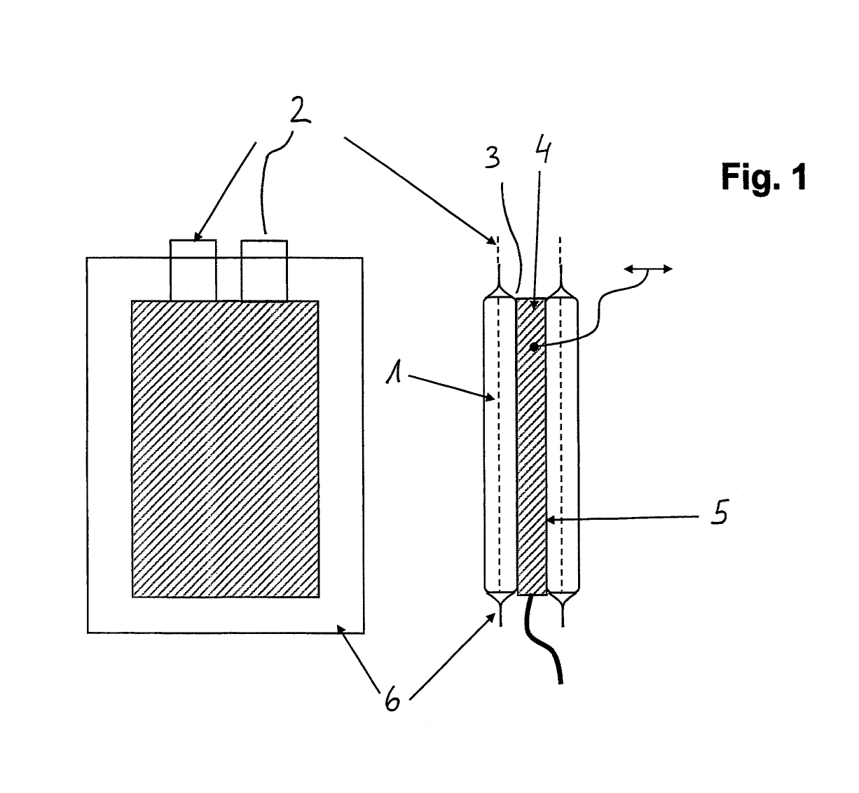

The left-hand view in FIG. 1 is a top view of an arrangement of two cells 1 of a battery from which electrode discharge plates 2 are protruding. The right-hand view is a lateral view of the cells 1. Shown schematically is a battery consisting of at least two cells 1 positioned side by side, which between the two form an intermediary space 3. The intermediary space 3 is filled with a porous and deformable compensating element 4 for controlling the temperature of the cells 1.

The compensating element 4 has a thermally conductive surface 5 which establishes a thermal contact with a cell surface. The double arrow represents the direction of compression of the compensating element 4. The compensating element 4 is in the form of a non-woven material. The cells 1 are in the form of “coffee-bag” cells with a sealing seam 6.

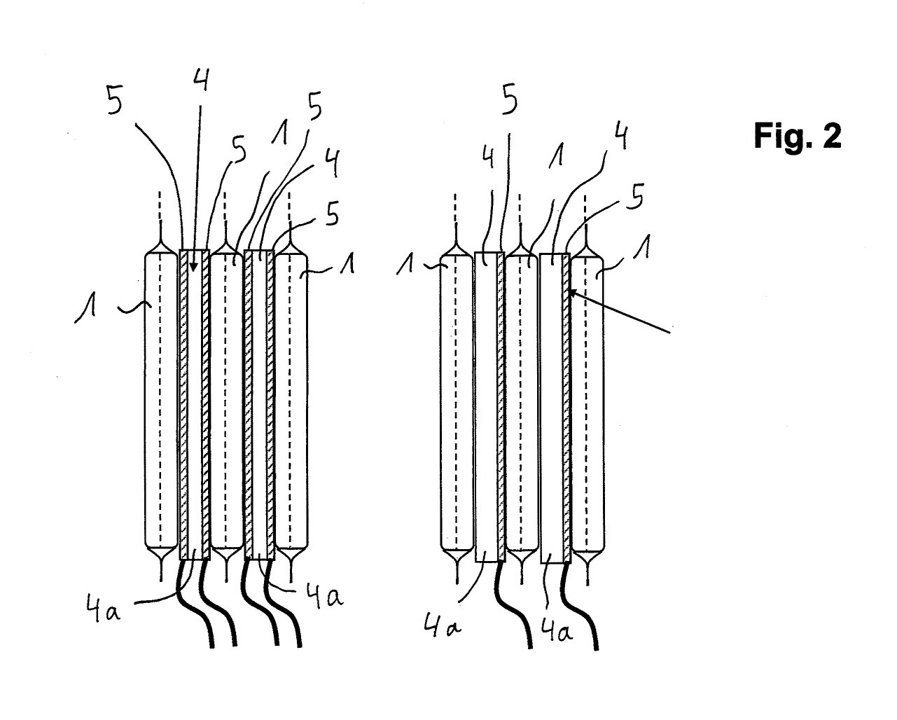

The left-hand view in FIG. 2 shows an arrangement of three cells 1, between which are arranged compensating elements 4 that are layered on both sides with thermally conductive surfaces 5. The compensating elements 4 consist of a base body 4a made of a non-woven material which is provided with a thermally conductive layer. The thermally conductive layer is in the form of an aluminum foil, which is laminated onto the non-woven material. Using a metal for fabricating the layer creates an electrical conductivity in the compensating element 4. The thermal and electrical conductivity are continuous and ensured over the entire surface of the compensating element 4.

The right-hand view in FIG. 2 shows an arrangement of three cells 1, between which are arranged compensating elements 4 that are layered on one side with thermally conductive surfaces 5. The compensating elements 4 consist of a base body 4a made of a non-woven material provided with a thermally conductive layer. The thermally conductive layer is in the form of an aluminum foil, which is laminated onto the non-woven material. Using a metal for fabricating the layer creates an electrical conductivity in the compensating element 4. The thermal and electrical conductivity are continuous and ensured over the entire surface of the compensating element 4.

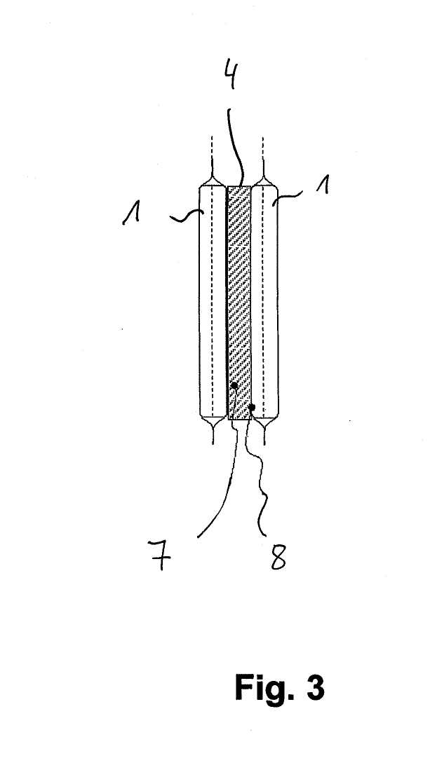

FIG. 3 shows an arrangement of two cells 1, between which a compensating element 1 is disposed. The compensating element 4 accommodates a pressure sensor 7 and housed between the compensating element 4 and a cell 1 is a temperature sensor 8. Integrating a temperature sensor 8 in the compensating element 4 allows the temperature to be measured on the spot and to be quickly regulated. Integrating a pressure sensor in the intermediary space 3 between the cells 1 allows for redundant safety monitoring. Aged or improperly overcharged “coffee-bag” cells exhibit a significant increase in thickness, displaying seemingly-“bloated cheeks”. This results in a detectable increase in pressure within the intermediary space 3.

With respect to further advantageous developments and refinements of the teaching according to the present invention, reference is made to both the general part of the description and to the claims attached hereto.

Finally, it must be emphasized in particular that the foregoing, selected exemplary embodiments serve purely as a basis for discussion of the teaching of the present invention; the teaching however, is not limited to these exemplary embodiments.

What is claimed is:

1. A battery, comprising at least two cells positioned side by side, which between the two form an intermediary space, wherein the intermediary space is filled with a porous and deformable compensating element for controlling the temperature of the cells.

2. The battery according to claim 1, wherein the compensating element has a thermally conductive surface.

3. The battery according to claim 1, wherein the compensating element is in the form of a ply surrounding the cells in zigzag fashion.

4. The battery according to claim 1, wherein the compensating element includes an elastomer material.

5. The battery according to claim 1, wherein the compensating element includes a foam material.

6. The battery according to claim 1, wherein the compensating element includes a non-woven material.

7. The battery according to claim 1, wherein the compensating element is flame-retardant.

8. The battery according to claim 1, wherein the compensating element includes an adhesive.

9. The battery according to claim 1, wherein the compensating element includes superabsorbent materials.

10. The battery according to claim 1, wherein the compensating element includes embossing.
